(19) United States
(12) Patent Application Publication
(10) Pub. No.: US 2025/0252297 A1
(43) Pub. Date: Aug. 7, 2025

(54) NEUROMORPHIC UNIT FOR PARALLEL NEURAL NETWORK WORKLOADS

(71) Applicant: Intel Corporation, Santa Clara, CA (US)

(72) Inventors: Rodrigo Aldana Lopez, Zapopan (MX); Leobardo Campos Macias, Guadalajara (MX); David Gomez Gutierrez, Tlaquepaque (MX); Sumit Bam Shrestha, San Jose, CA (US)

(73) Assignee: Intel Corporation, Santa Clara, CA (US)

(21) Appl. No.: 19/190,113

(22) Filed: Apr. 25, 2025

(51) Int. Cl. G06N 3/049

(52) U.S. Cl. CPC G06N 3/049

(57) ABSTRACT

An apparatus may have a neuromorphic architecture and facilitate parallel neural network workloads. The apparatus may include neurons and connections between the neurons. The neurons may perform computations in the neural network and produce payloads and may transmit payloads to each other in the form of spikes. The spike messages may be orthogonally modulated spikes that facilitate executions of the neural network to process multiple inputs to the neural network through parallel workloads. A spike message may indicate a payload and identify the workload through which the payload is produced. A neuron may combine multiple spikes into a combined spike. The combined spike may represent all the payloads and workloads in the spike messages. The neuron may send the combined spike to another neuron, which may decode the combined spike to obtain a payload for performing a neural network operation for a workload that it is assigned to.

### TECHNICAL FIELD

This disclosure relates generally to neural networks (also referred to as “deep neural networks” or “DNN”), and more specifically, modulated spikes in neuromorphic units for enabling parallel DNN workloads.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an artificial intelligence (AI) system, in accordance with various embodiments.

FIG. 2 illustrates parallel DNN workload processing, in accordance with various embodiments.

FIG. 3 illustrates parallelized synapse processing, in accordance with various embodiments.

FIGS. 4A and 4B illustrate communicative connections between cores, in accordance with various embodiments.

FIG. 5 illustrates an example spiking neuromorphic unit, in accordance with various embodiments.

FIG. 6 illustrates a CNN, in accordance with various embodiments.

FIG. 7 illustrates an example convolution, in accordance with various embodiments.

FIG. 8 is a flowchart showing a method of parallel DNN workload processing, in accordance with various embodiments.

FIG. 9 is a block diagram of an example computing device, in accordance with various embodiments.

### DETAILED DESCRIPTION

The last decade has witnessed a rapid rise in artificial intelligence (AI) based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution, matrix multiplication, layer normalization, batch normalization, SoftMax operation, pooling, elementwise operation, linear operation, nonlinear operation, and so on.

Input or output data of deep learning operations may be arranged in data structures called tensors. A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

Tensors in DNNs can be saved in X-major (e.g., XYZ or XZY format), Y-major formats (e.g., YXZ or YZX format), or Z-major formats (e.g., ZXY or ZYX format). The format of a tensor may define the order in which the data points in the tensor are stored, written, or read. The first character may represent the dimension in which data points are contiguous in memory. The second character may represent the dimension in which data points can be accessed after the contiguous data points are accessed in memory. The third character may represent the dimension in which data points are accessed after the data points in the dimension represented by the second character are exhausted. Taking the ZXY format for example, the access order first starts in the Z dimension, then moves to the X dimension, and finally moves to the Y dimension. Data points in the tensor are contiguous in memory in the Z dimension, meaning data points having the same (x, y) coordinates are contiguous in memory. Using tensor permutation, the tensor may be read from memory in a different format.

Parallel processing multiple inputs to a DNN may be needed or desired for many applications, such as image recognition, language processing, and so on. For instance, multiple images may be input into a DNN and each of the images may be processed independently by executing the DNN. Multiple independent workloads may be executed simultaneously to parallel process the images in the DNN to predict classifications of the images. Each workload may have a separate input to the DNN and a separate output from the DNN. However, hardware devices suitable for executing parallel DNN workloads are limited.

Currently available neuromorphic chips excel in parallel processing but face significant limitations in managing multiple independent workloads simultaneously. Some neuromorphic chips are capable of sequential execution to manage multiple workloads. However, there is currently no solution for simultaneously handling multiple independent workloads on neuromorphic chips. Currently available implementations can manage single workloads in parallel but limit the chip's ability to process multiple tasks simultaneously and independently. When multiple workloads are executed in parallel, it is typically important to accurately distinguish each workload's spikes to maintain the integrity of the results. Currently available approaches that embed workload IDs within spike payloads suffer from various drawbacks, such as handling each spike separately, leading to inefficient processing, and consuming valuable payload space, which reduces the data-carrying capacity for each spike.

Embodiments of the present disclosure may improve on at least some of the challenges and issues described above by providing modulated spikes (such as orthogonally modulated spikes) in neuromorphic units for enabling parallel DNN workloads. This approach allows multiple spike streams to coexist within the same DNN without causing interference and therefore, it can facilitate efficient parallel execution of multiple workloads on the neuromorphic architecture, enabling the simultaneous processing of batches. This approach can optimize the capabilities of hardware devices (e.g., neuromorphic units) to handle multiple tasks simultaneously.

In various embodiments of the present disclosure, a neuromorphic unit may include neurons and connections among the neurons. A neuron may be a core, also referred to as “computing core.” The connection between two neurons may facilitate transmission of spikes (also referred to as “spike messages”) between the two neurons. The connection may include one or more data paths. A data path may have a data path width indicating the number of bits that can be transmitted at a time. For instance, the data path width may be 16 bits, 32 bits, 64 bits, and so on. The neuromorphic unit may use a DNN to currently perform multiple independent workloads. Each workload may have an input to the DNN and an output from the DNN. The inputs for different workloads may be different. During the execution of the parallel workloads, neurons in the neuromorphic unit may carry out neural network operations in the DNN. Examples of the neural network operations may include convolution, matrix multiplication, layer normalization, batch normalization, SoftMax operation, pooling, elementwise operation, linear operation, nonlinear operation, and so on. A neuron, after it computes an output data element of a neural network operation for a workload, may generate a spike and transmit the spike to one or more other neurons. The spike may include data representing both the payload (e.g., the value of the output data element) and the workload (e.g., workload ID).

Neurons may leverage Code Division Multiple Access (CDMA) techniques to modulate spikes. Spike modulation may refer to modifying spike signals to encode information, e.g., information for distinguishing tasks within parallel workload processing. Neurons may modulate spikes through orthogonal coding, which is a technique that uses unique codes to differentiate between parallel tasks or signals without interface. In an example, workload IDs may be represented by one-hot codes. A one-hot code may be a sequence of bits that includes a single one bit and one or more zero bits. The position of the one bit in the one-hot code may indicate the corresponding workload ID and differentiate the workload from the other workloads. Workload identification information may be embedded within spike payloads to label or identify different workloads. A payload (e.g., bits representing the value of an output data element computed in a workload) may be modified by using the one-hot code of the workload to generate an orthogonally modulated spike. The orthogonally modulated spike represents both the payload and the workload ID. The spikes transmitting within the neuromorphic unit may all have the same number of bits, which may be determined by the data path width of the neuromorphic unit. After a neuron generates a spike, it may take one or more actions on the spike, which may include using the spike to perform the next neural network operation in the DNN, storing the spike, combining the buffer with one or more other spikes, transmitting the spike to one or more other neurons, or some combination thereof.

As multiple workloads are being executed concurrently, a neuron may have multiple spikes corresponding to different workloads at the same time. The neuron may include a data storage unit (e.g., a buffer) to store spikes. The neuron may combine multiple spikes into a single one, which is referred to as a combined spike. The combined spike may have the same number of bits as each of the spikes. The neuron may combine the spikes when its buffer is full, e.g., the storage capacity of its buffer is reached. The neuron may send the combined spike to one or more neurons. Additionally or alternatively, the neuron may decode the combined spike for carrying out further computations. Spike decoding may be a process of interpreting or distinguishing between different spike messages to separate workload-specific data. To decode the combined spike, either at the neuron or another neuro receiving the combine spike from the neuron, dot products may be computed from the one-hot code of the target workload and the combined spike. The dots products may constitute the payload of the target workload. The neuron may compute new data from the payload by performing a neural network operation in the DNN and generate a new spike from the new data. The new spike may further be stored, transmitted, combined with one or more other spikes, or used for further computations. This process may continue till all the workloads are finished.

This disclosure provides a novel advancement, enabling true parallelism for distinct workloads on neuromorphic architectures. Independent DNN workloads can be performed concurrently, which can significantly enhance efficiency and processing capabilities of the hardware device. This disclosure introduces a novel method for combining and decoding spikes to aggregate spike messages and a bit field decoding technique to separate tasks. This process enables efficient handling and identification of multiple tasks within a single spike buffer, minimizing processing delays and improving real-time performance. The method supports both orthogonal and quasi-orthogonal modulations mechanisms. Quasi-orthogonal modulations are communication techniques where waveforms can be designed to have low cross-correlation. Typically, the waveforms are not perfectly orthogonal but can exhibit a significant degree of independence. This can allow for multiple signals to be transmitted simultaneously with minimal interference. Using quasi-orthogonal modulations mechanisms can further increase throughput beyond theoretical limits at the expense of a small error. The approach in this disclosure can enhance parallel workload processing in neuromorphic architecture. It can also increase payload capacity and data-carrying capability through network optimization, such as adding more connections between neurons to enable more data to be transmitted per spike.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phase “A or B” means (A), (B), or (A and B). For the purposes of the present disclosure, the phrase “A, B, and/or C” or the phase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations may be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

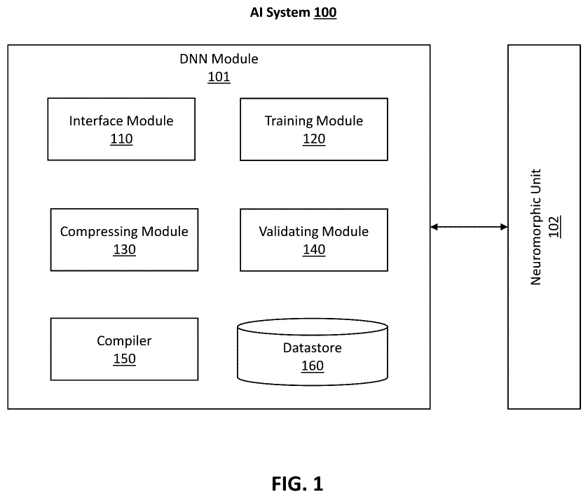

FIG. 1 is a block diagram of an AI system 100, in accordance with various embodiments. The AI system 100 may be part of a computing device with AI capabilities, such as an AI personal computer (PC) or AI server. The AI system 100 includes a DNN module 101 and a neuromorphic unit 102. In other embodiments, alternative configurations, different or additional components may be included in the AI system 100. For instance, the AI system 100 may include multiple DNN modules or multiple neuromorphic units. Further, functionality attributed to a component of the AI system 100 may be accomplished by a different component included in the AI system 100 or a different system. In some embodiments, the DNN module 101 and DNN accelerator 102 may include different types of processing units. In an example, the DNN module 101 may be implemented by one or more central processing units (CPUs). The neuromorphic unit 102 may be at least part of a neural processing unit. The DNN module 101 and neuromorphic unit 102 may be implemented in the same chip or separate chips.

The DNN module 101 facilitates generation and deployment of DNNs, including DNN-based parallel workload processing. As shown in FIG. 1, the AI system 100 includes an interface module 110, a training module 120, a compressing module 130, a validating module 140, a compiler 150, and a datastore 160. In other embodiments, alternative configurations, different or additional components may be included in the AI system 100. Further, functionality attributed to a component of the AI system 100 may be accomplished by a different component included in the AI system 100 or a different module or system.

The interface module 110 facilitates communications of the AI system 100 with other modules or systems. For example, the interface module 110 establishes communications between the AI system 100 with an external database to receive data that can be used to train DNNs or to receive inputs into DNNs to perform AI tasks. As another example, the interface module 110 transmits configuration parameters to the neuromorphic unit 102 for configuring components of the neuromorphic unit 102 for DNN executions, including parallel DNN executions. As yet another example, the interface module 110 supports the AI system 100 to distribute outputs of DNNs to other systems, e.g., computing devices (e.g., robots, vehicles, mobile devices, personal computers, etc.) configured to apply DNN outputs to perform tasks.

The training module 120 trains DNNs by using a training dataset. The training module 120 may form the training dataset. In an example where the training module 120 trains a DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 140 to validate performance of a trained DNN. The portion of the training dataset not including the tuning subset and the validation subset may be used to train the DNN.

The training module 120 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 1, 10, 10, 100, 100, 1000, or even larger.

The training module 120 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully-connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between two convolution layers. A fully-connected layer involves weights, biases, and neurons. It connects neurons in one layer to neurons in another layer. It is used to classify images between different categories by training.

In the process of defining the architecture of the DNN, the training module 120 also adds an activation function to a hidden layer or the output layer. An activation function of a layer transforms the weighted sum of the input of the layer to an output of the layer. The activation function may be, for example, a ReLU (Rectified Linear Unit) activation function, a tangent activation function, or other types of activation functions.

After the training module 120 defines the architecture of the DNN, the training module 120 inputs a training dataset into the DNN. The training dataset includes a plurality of training samples. An example of a training sample includes an object in an image and a ground-truth label of the object. The training module 120 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 120 uses a cost function to minimize the error.

The training module 120 may train the DNN for a predetermined number of epochs. The number of epochs is a hyperparameter that defines the number of times that the deep learning algorithm is to work through the entire training dataset. One epoch means that each sample in the training dataset has had an opportunity to update internal parameters of the DNN. After the training module 120 finishes the predetermined number of epochs, the training module 120 may stop updating the parameters in the DNN. The DNN having the updated parameters is referred to as a trained DNN.

The compressing module 130 compresses DNNs. For instance, the compressing module 130 may add pruning operations to DNN layers to reduce computational complexity or memory usage. A pruning operation may prune weight tensors of a DNN layer by changing one or more non-zero weights of the layer to zeros. The modification may be done before, during, or after training. Weights may be pruned during training, during inference, or a combination of both. The compressing module 130 may determine a sparsity ratio for a DNN layer. The sparsity ratio may be a ratio of the number of zero-valued weight to the total number of weights in the layer. The compressing module 130 may perform the pruning operation till the sparsity ratio of the DNN layer meets a target sparsity ration, such as 10%, 20%, 30%, 10%, 10%, and so on.

In some embodiments, the compressing module 130 may select a structured sparsity pattern for a DNN layer and prunes weight of the DNN layer to reach the structured sparsity pattern. The structured sparsity pattern may be represented by a structured sparsity ratio N:M. In the pruning process, the compressing module 130 may divide a kernel into weight blocks, each of which include M consecutive weights. For each of the weight blocks, the compressing module 130 may select N element(s) and change the value of the unselected element(s) in the weight block to zero. The compressing module 130 may generate sparsity maps that indicate weight sparsity. In some embodiments, the compressing module 130 may generate a sparsity map for each weight block. The sparsity map may include M sparsity elements corresponding to the M weights in the weight block. Each sparsity element may indicate whether the corresponding weight is zero or not. In some embodiments, the compressing module 130 may compress sparsity maps to generate compressed maps. A compressed map has less elements than the sparsity map from which the compressed map is generated. The compressing module 130 may write the sparsity maps or compressed maps into a memory.

In some embodiments, the compressing module 130 may select one or more layers in a DNN and modify each selected layer with a pruning operation. For instance, the compressing module 130 may select computationally complex layers, such as layers with large filters. For a pruning operation of a layer or of a type of layer, the compressing module 130 may determine a weight threshold that would not cause a loss of the accuracy of the DNN to exceed an accuracy loss constraint. A pruning operation may modify weights having absolute values above the weight threshold to zeros and leave the other weights unchanged. The weight pruning can reduce memory storage as zero-valued weights may not be stored. Also, the number of operations in the layer can be reduced as computations on zero-valued weights can be skipped without impacting the output of the layer. In some embodiments, the compressing module 130 may also measure energy saving, final DNN accuracy, or layer-wise sparsity caused by pruning operations.

After compressing a DNN, the compressing module 130 may fine tune the DNN, e.g., through a retraining process. The compressing module 130 may fine tunes DNNs after weights are pruned. In some embodiments, the fine-tuning process is a retraining or further training process. For instance, after weights in a DNN are pruned, the compressing module 130 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the compressing module 130 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the compressing module 130, the compressing module 130 may perform a new pruning process, e.g., by selecting weight blocks and pruning the selected weight blocks. In some embodiments, the weight pruning process may be repeated multiple times before the fine-tuning process is done. In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 1, 1, and so on.

The validating module 140 verifies accuracy of trained or compressed DNNs. In some embodiments, the validating module 140 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 140 may determine an accuracy score measuring the precision, recall, or a combination of precision and recall of the DNN. The validating module 140 may use the following metrics to determine the accuracy score: Precision=TP/(TP+FP) and Recall=TP/(TP+FN), where precision may be how many the DNN correctly predicted (TP or true positives) out of the total it predicted (TP+FP or false positives), and recall may be how many the DNN correctly predicted (TP) out of the total number of objects that did have the property in question (TP+FN or false negatives). The F-score (F-score=2*PR/(P+R)) unifies precision and recall into a single measure.

The validating module 140 may compare the accuracy score with a threshold score. In an example where the validating module 140 determines that the accuracy score of the DNN is less than the threshold score, the validating module 140 instructs the training module 120 to re-train the DNN. In one embodiment, the training module 120 may iteratively re-train the DNN until the occurrence of a stopping condition, such as the accuracy measurement indication that the DNN may be sufficiently accurate, or a number of training rounds having taken place.

The compiler 150 compiles DNNs to executable instructions that can be executed, e.g., by the neuromorphic unit 102, to carry out neural network operations in DNNs. In some embodiments, the compiler 105 may generate a graph representing a DNN. The graph may include nodes and edges. A node may represent a specific neural network operation in the DNN. An edge may connect two nodes and represent a connection between the two corresponding neural network operations. In an example, an edge may encode a tensor that flows from one of the neural network operations to the other neural network operation. The tensor may be an output tensor of the first neural network operation and an input tensor of the second neural network operation. The edge may encode one or more attributes of the tensor, such as size, shape, storage format, and so on. The compiler 150 may use the graph to generate executable DNNs. For instance, the compiler may generate computer program instructions (e.g., compilation descriptors) for executing DNNs. The instructions may be stored in registers associated with components of the neuromorphic unit 102, such as neurons in the neuromorphic unit 102.

The compiler 150 may generate configuration parameters that facilitates data read or data write, such as a configuration parameter that indicates the number of data elements to be processed (e.g., the number of data elements in a tile), configuration parameter that indicates the memory address where an input data element may be fetched, configuration parameter that indicates memory address where an output data element may be stored, configuration parameter that indicates memory address where another configuration parameters may be stored, and so on.

The compiler 150 may generate configuration parameters that enable the neuromorphic unit 102 to execute DNN workloads in parallel. The DNN workloads may be workloads of executing the same DNN using different inputs to the DNN. The workloads are executed by the neuromorphic unit 102 concurrently and independently. The compiler 150 may assign neurons in the neuromorphic unit 102 to the workloads. For example, the compiler 150 may generate configuration parameters that indicate which neuron is to perform which neural network operation(s) in the DNN for which workload(s). The compiler 150 may also program communicative connections between neurons. For instance, the compiler 150 may enable or disable communicative connections between particular neurons for facilitating parallel workload processing. In some embodiments, the compiler 150 may allow communication between two neurons for a workload but prevent communication between the two neurons for another workload being executed in parallel with the workload.

In some embodiments, the compiler 150 may generate codes that can identify each of the workloads. These codes may be used as workload IDs. In some embodiments, the compiler 150 may generate orthogonal codes as workload IDs. The orthogonal one-hot codes may be one-hot codes denoted as:

$${C}_{i} \cdot {C}_{j} = \{ \begin{matrix}1 & i \neq j \\ 0 & i = j\end{matrix}$$

where ⋅ represents the inner-product operation of computing a bitwise AND, which summarizes all N results, and N is the total number of workloads in parallel. That way, neurons in the neuromorphic unit 102 can produce spikes for a particular workload and send a graded spike (instead of a usual short spike) with the one-hot code for the particular workload as the payload. The one-hot codes may be generated during the compilation stage, which is before the execution of the DNN starts, and may be used during runtime (i.e., during the execution of the DNN) by the neuromorphic unit 102 to generate orthogonally modulated spikes.

The compiler 150 may generate the one-hot codes based on one or more factors, such as the total number of workloads to be executed concurrently, data path width of the neuromorphic unit 102, the number of bits for a payload, other factors or some combination thereof. In an example in which there are four workloads in parallel and the data path width is 32 bits, the compiler 150 may determine that each one-hot code representing a workload ID has four bits, resulting in four bits of effective payload available. The four workloads may be represented by four different one-hot codes: [1000], [0100], [0010], and [0001], respectively. In another example in which there are 32 workloads to be executed in parallel, the compiler 150 may generate 32 one-hot codes as workload IDs:

$$\begin{matrix}{C}_{1} = [ 1000 - 0000 - 0000 - 0000 ] , \\ {C}_{1} = [ 0100 - 0000 - 0000 - 0000 ] , \\ … , and \\ {C}_{32} = [ 0000 - 0000 - 0000 - 0001 ]\end{matrix}$$

With the same data path width of 32 bits, when there are two workloads, each one-hot code may have two bits, resulting in 16 bits of effective payload available; while when there are eight workloads in parallel, each one-hot code may have eight bits, resulting in two bits of effective payload available. When there is one workload to be executed by the neuromorphic unit 102, 32 bits of effective payload would be available, and the compiler 150 may generate no one-hot codes as distinguishing workloads would not be needed.

In some embodiments, the compiler 150 may generate other types of codes as workload IDs, such as quasi-orthogonal codes. By using quasi-orthogonal modulation instead of orthogonal modulation, the throughput (e.g., the amount of available parallel workloads) can be increased with the expense of a small error probability. While n orthogonal codes exist of length n in binary, several quasi-orthogonal code families exist that are close to orthogonality and produce more than n codes of length n. In an example, the compiler 150 may use Gold codes, which are quasi-orthogonal with low cross-correlation, thus having a small error probability when separating messages. There are 2^{m}+1 codes for length n=2^{m}−1 (for example, 9 codes for n=7). In another example, the compiler 150 may use Kasami codes that are quasi-orthogonal with uniformly low cross-correlation, thus having a slightly lower error probability than Gold codes. There may be approximately \sqrt{2^{m}} (small set) or 2^{m/2}\sqrt{2^{m}} (large set) codes for length n=2^{m}−1 (for example, 6-42 codes for n=7). In yet another example, the compiler 150 may use pseudo-random noise sequences, which are quasi-orthogonal with low cross-correlation. Pseudo-random noise sequences may have moderate error probability and can be effective in low-noise settings. There may be up to 2ⁿ−1 codes using an n-stage Linear Feedback Shift Register (LFSR). For example, 15 codes for n=4.

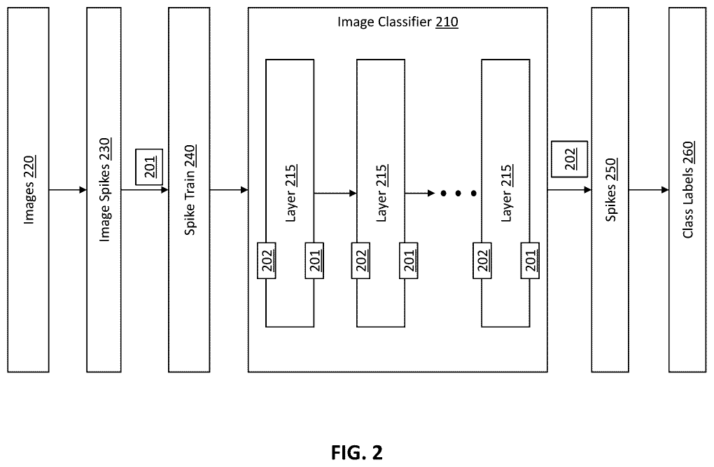

In some embodiments, the compiler 150 may also convert inputs to the DNN into spikes (“input spikes”). The input spikes may be binary spikes that may pass through layers of the DNN that are to be executed by the neuromorphic unit 102. The compile 150 may generate the input spikes using the orthogonal (or quasi-orthogonal) codes representing workload IDs. The compiler 150 may mask a binary spike, which is converted from an input to the DNN, into a message. The compiler 150 may provide the messages for all the workloads to the neuromorphic unit 102 at the same time for parallel executions of the DNN. Certain aspects regarding inputs and parallel executions are described below in conjunction with FIGS. 2-4.

The datastore 160 stores data received, generated, used, or otherwise associated with the AI system 100. For example, the datastore 160 stores the datasets used by the training module 120 and validating module 140, such as the hyperparameters for training DNNs, internal parameters of trained DNNs (e.g., weights, etc.), data for sparsity acceleration (e.g., sparsity masks, etc.), and so on. The datastore 160 may store configuration parameters, one-hot codes, input spikes, or other data generated by the compiler 150. The datastore 160 may include one or more memories. In the embodiment of FIG. 1, the datastore 160 is a component of the AI system 100. In other embodiments, the datastore 160 may be external to the AI system 100 and communicate with the AI system 100 through a network.

The neuromorphic unit 102 is a hardware apparatus with a neuromorphic architecture. The neuromorphic unit 102 may also be referred to as a spiking neuromorphic unit. In some embodiments, the neuromorphic unit 102 may include a plurality of compute elements, which may be grouped into one or more compute blocks. A compute element can perform computations, such as accumulation, subtraction, multiplication, division, other types of computations, or some combination thereof. In some embodiments, a compute element may be a neuron (also referred to as “core”). In other embodiments, multiple compute elements may constitute a neuron. A compute element may be communicatively connected to one or more other compute elements, which may be in the same compute block as the compute element or in a different compute block. In some embodiments, the communicative connection, which may be referred to as a synapse, between two compute elements may provide a data path with a predetermined data path width, such as 16 bits, 32 bits, 64 bits, and so on. The communicative connections between neurons may be preprogrammed, e.g., by the compiler 150. The compute elements in communicative connection may send data to each other, e.g., when the compute elements spike. The communication between two compute elements may be bidirectional so that they can pass spikes to each other in both forward spike propagation and backward spike propagation.

The neuromorphic unit 102 can execute multiple, independent DNN workloads simultaneously. The DNN workloads may be workloads of processing multiple inputs using the same DNN. Neurons in the neuromorphic unit 102 may perform the computations in the DNN when the inputs propagate through the layers of the DNN. A neuron may spike after an output data element of a neural network operation or a layer in the DNN is computed by the neuron for a workload. The neuron may modulate the spike with the orthogonal (or quais-orthogonal) code representing the ID of the workload. The spike may encode both the payload and the workload. In an example in which the workload ID is represented by a one-hot code and the payload is [1010], the spike may be [0100-0000-0000-0100], which is generated by replacing every 1 in the payload by the one-hot code and replacing every 0 in the payload with [0000]. The number of bits in the spike may be equal to or less than the data path width of the neuromorphic unit neuromorphic unit 102.

A neuron may store spikes, such as spikes generated by the neuron or received by the neuron from other neurons, in its data storage. The data storage may be a buffer for example. The data storage may be inside the neuron or be allocated to the neuron. The neuron may have multiple spikes for multiple workloads at the same time. In some embodiments, the neuron may have spikes for all the workloads being parallel executed by the neuromorphic unit 102. In other embodiments, the neuron may have spikes for some of the workloads. The neuron may generate a combined spike from multiple spikes. The combined spike may have the same number of bits as a single spike. Storage and bandwidth can therefore be saved by combining the spikes. In some embodiments, the neuron may determine whether to combine spikes based on the status of its buffer. For instance, the neuron may check whether the storage capacity of its buffer is reached. In response to determining that the storage capacity of its buffer is reached (e.g., the buffer has no free space or insufficient free space for storing one extra spike), the neuron may combine the spikes. In other embodiments, the neuron may combine spikes based on a timeout mechanism. For instance, the neuron may determine how long it has been since it received the last spike and may combine spikes in response to determining that it has been a threshold amount of time or longer since it received the last spike.

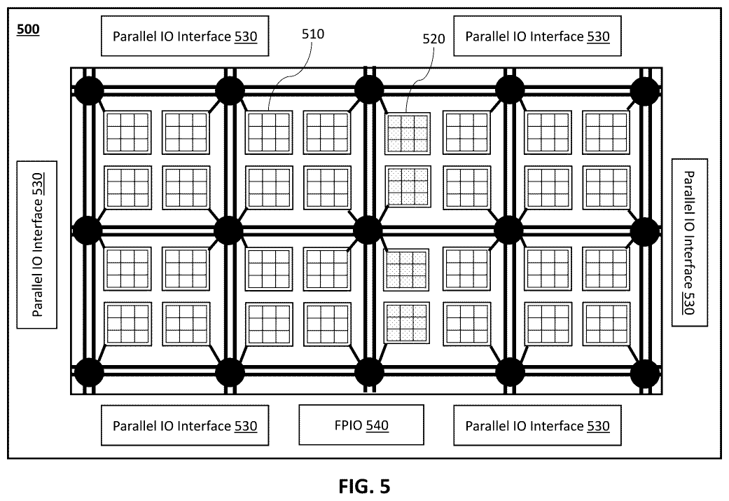

The neuron may send the combined spike to one or more neurons. Additionally or alternatively, the neuron may decode the combined spike for carrying out further computations in the DNN. The process of decoding the combined spike for performing a particular workload, either performed by the neuron or by another neuron receiving the combine spike from the neuron, may include extracting the payload for the particular workload from the combined spike. To extract the payload, the neuron decoding the combined spike may compute dot products from the one-hot code of the particular workload and the combined spike. The dots products may constitute the payload of the particular workload. The neuron may compute new data from the payload by performing a neural network operation in the DNN and generate a new spike from the new data. The new spike may further be stored, transmitted, combined with one or more other spikes, or used for further computations. This process may continue till all the workloads are finished. Certain aspects of spiking neuromorphic units are described below in conjunction with FIG. 5.

FIG. 2 illustrates parallel DNN workload processing, in accordance with various embodiments. The parallel DNN workload processing includes parallel processing multiple inputs independently to obtain multiple outputs. Each output is generated from a different input and the other inputs are not used. For the purpose of simplicity and illustration, the workloads in FIG. 2 are image classification tasks and classification of 32 images is done simultaneously. The DNN is an image classifier 210 that has been trained for classifying images. The image classifier 210 may include one or more convolutional layers with activation functions. In other embodiments, a different number of workloads may be performed simultaneously. Also, the workloads may be other types of AI tasks. The parallel workload processing may be performed by a neuromorphic unit, such as the neuromorphic unit 102 in FIG. 1.

As shown in FIG. 2, the image classifier 210 includes layers 215 (individually referred to as “layer 215”). Images 220 are 32 images used for executing 32 independent image classification workloads. The images 220 may be encoded into image spikes 230. The image spikes 230 may be 32 binary spikes. A binary spike may be a sequence of binary bits. The image spikes 230 are converted to a spike train 240 through a masking operation 201. The masking operation 201 may be a spike modulation process, in which spike signals are modified to encode information for distinguishing workloads within the parallel workload processing. The spike train 240 may be generated by leverage CDMA techniques to mix multiple messages inside a single spike. The spike train 240 is a combined spike that represents all the images 220.

In some embodiments, an image may be treated as a tensor, such as a 3D tensor with a spatial size of H×W×C. For instance, the image may have three channels (i.e., C=3), which may correspond to red, green, and blue, respectively. For each channel, the image may have a 2D matrix with a spatial size of H×W. Each data element in the 3D matrix may be a pixel in the channel. A single image spike may be converted from a single data element in the 3D tensor. The spike train 240 may represent a single data element from each of the N images. The spike train 240 may indicate both the payloads (e.g., values of the N data elements) and the workloads (e.g., information identifying which image/workload each payment belongs to). For the purpose of illustration and simplicity, FIG. 2 shows a single spike train. There may be a plurality of spike trains generated for the parallel workload process as an image may have H×W×C data elements.

In some embodiments, the total number of bits in the spike train 240, which may be the total number of workloads being executed in parallel, may equal the data path width of neuromorphic unit. In this example, the data path width of the neuromorphic unit is 32 bits, and the spike train 240 may have 32 bits in total. Each bit in the spike train 240 may correspond to a different one of the images 220. This approach can effectively utilize the synapse communication bandwidth of the neuromorphic unit and enable the execution of up to 32 parallel tasks using short spikes (or up to 16 tasks with graded spikes), allowing multiple workloads to coexist and be processed simultaneously without interference. Similar improvements can be achieved in other neuromorphic chips.

The spike train 240, which is a single spike, is input into the image classifier 210 and propagates through the layers 215. An unmasking operation 202 may be performed on the spike train 240 before the first layer is executed. The unmasking operation 202 may include AND operations. In the example of running 32 tasks in parallel, the unmasking operation 202 may include 32 AND operation. The non-zero results corresponding to the images 220 may be evaluated as activations. Using parallelized synapse processing, the weight matrices may be stacked corresponding to the number of tasks to computer, which can be up to 32 in the example described above. The result computed from the activations and weights may then be input into an activation function, which may be executed by a leaky integrate-and-fire (LIF) neuron with the same bias and voltage threshold. The same parallelized synapse processing may be used. In the example having 32 tasks, 32 voltages may be needed at each LIF neuron to determine whether a binary spike is emitted. After the execution of the first layer, the masking operation 201 may be performed again on new spikes generated from the execution of the first layer. As shown in FIG. 2, each layer 215 is associated with the unmasking operation 202 and masking operation 201. This approach ensures efficient parallel processing and optimal utilization of computational resources, except for the last layer where the binary spikes are taken as they are for the classification task.

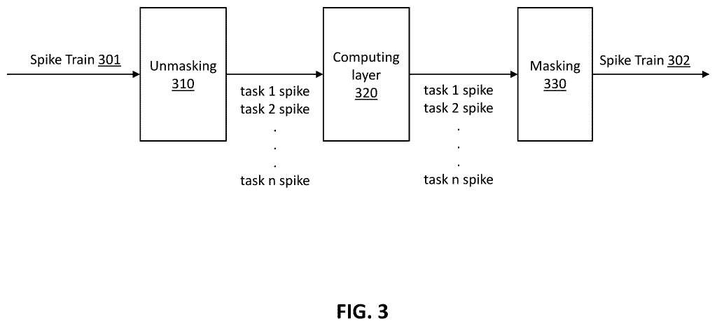

After the layers 215 are executed, the output stage may begin. At the output stage, the final spike train is converted to spikes 250 through the unmasking operation 202. The spikes 250 may represent the outputs of the image classifier 210. The outputs correspond to the images 220, respectively. The spikes 250 may be used to generate class labels 260. The class labels 260 may include a separate label for each of the images 220. Certain aspects of masking and unmasking are described below in conjunction with FIG. 3.

FIG. 3 illustrates parallelized synapse processing, in accordance with various embodiments. FIG. 3 show three operations: unmasking 310, computing layer 320, and masking 330. The three operations may be performed by a neuron in a neuromorphic unit, such as the neuromorphic unit 102 in FIG. 1, during parallel workload processing, such as the parallel workload processing shown in FIG. 2. The unmasking 310 may be an example of the unmasking operation 202 in FIG. 2. The masking 330 may be an example of the masking operation 201. The computing layer 320 may be computing a layer 215 in the image classifier 210.

As shown in FIG. 3, the unmasking 310 is performed first on a spike train 301. The spike train 301 may be the spike train 240 in FIG. 2 or computed from the spike train 240. In some embodiments, the spike train 301 is a combined spike that carries information for multiple workloads that are being executed in parallel. For the purpose of illustration, the spike train 301 has information for n workloads (task 1 through task n) in FIG. 3. The unmasking 310 decodes the spike train 301 into n spikes for the n workloads, respectively. The computing layer 320 may be performed on the n spikes and generates n new spikes by carrying out one or more neural network operations in the DNN layer. The n spikes may be an input data element of the DNN layer for each of the n workloads. The n new spikes may be an output data element of the DNN layer for each of the n workloads. The masking 330 is then performed on the n new spikes and combines the n new spikes into a spike train 302. The masking 330 may be followed by another unmasking operation and another computing layer operation for another DNN layer. This unmasking-computing-masking (or masking-unmasking-computing) process may be repeated till all the relevant DNN layers are executed.

In some embodiments, the computing layer 320 is not performed on all the n spikes. Rather, the computing layer 320 may be performed on a subset of the n spikes, like m spike(s), where m may be 1 or another integer that is smaller than n. The n new spikes after the computing layer 320 may include m spike(s) with new payload data and n-m spike(s) whose payload data remains the same.

In some embodiments, before the unmasking 310, a neuron may obtain (e.g., receive or generate) spikes for some or all of the workloads and combine the spikes into the spike train 301. One or more of these spikes may be unmodulated. As an illustrative example, the neuromorphic unit executes a total of four workloads in paralegal. The four workloads have one-hot codes [1 0 0 0], [0 1 0 0], [0 0 1 0], [0 0 0 1], respectively, as workload IDs. Workloads 2 and 3 transmit a spike with effective payloads [1 1 0 0] and [0 1 0 1], respectively. Graded spikes for the two workloads may be generated by embedding the one-hot codes into the payloads. For instance, the payload for the i-th workload is modulated using the codes by the rules: every 1 in the payload is substituted by wᵢ; and every 0 in the payload is substituted by 0. Following these rules, the graded spike for workload 2 is [0 1 0 0-0 1 0 0-0 0 0 0-0 0 0 0]; and the graded spike for the payload for workload 3 is [0 0 0 0-0 0 1 0-0 0 0 0-0 0 1 0]. An OR operation is then performed on the two spike messages to generate the spike train 301, which is [0100-0110-0000-0010]. The combination may be done to save data storage space or bandwidth.

The unmasking 310 may be performed by another neuron that receives the spike train 301. The unmasking 310 is for distinguishing between workloads, e.g., because the spike train 301 has arrived at the destination, meaning it has arrived at a neuron assigned to perform DNN computation for workloads included in the spike train 301. To detect whether workload i contributed to a particular spike, the payload is separated into blocks of bits corresponding to the size of the orthogonal code (in this example, 4 bits). Inner product is performed between the i-th code and each block. In situations where all blocks inner product result in 0, no contribution is detected. In situations where at least one block obtains a 1, the inner products correspond to the payload. For workload 2, the following dot products are produced:

$$1. [ 0100 ] \cdot [ 0100 ] = 1$$

$$2. [ 0110 ] \cdot [ 0100 ] = 1$$

$$3. [ 0000 ] \cdot [ 0100 ] = 0$$

$$4. [ 0010 ] \cdot [ 0100 ] = 0 ,$$

effectively recovering the payload [1 1 0 0]. For workload 3:

$$1. [ 0100 ] \cdot [ 0010 ] = 0$$

$$2. [ 0110 ] \cdot [ 0010 ] = 1$$

$$3. [ 0000 ] \cdot [ 0010 ] = 0$$

$$4. [ 0010 ] \cdot [ 0010 ] = 1 ,$$

effectively recovering the payload [0 1 0 1]. The computing layer 320 may be performed on the recovered payloads for workload 2 and workload 3 and produce new payloads and [0111], respectively.

During the masking 330, new graded spikes for workload 2 and workload 3 with the new payloads may be generated through spike modulation. For instance, every 1 in the payload is substituted by wᵢ, and every 0 in the payload is substituted by 0. The new modulated spike for workload 2 is [0 1 0 0-0 1 0 0-0 1 0 0-0 0 0 0]. The new modulated spike for workload 3 is [0 0 0 0-0 0 1 0-0 0 1 0-0 0 1 0]. An OR operation may be performed to combine the two spike messages and produce a combined spike [0 1 0 0-0 1 1 0-0 1 010-0 0 1 0]. In some embodiments, more spikes may be combined. For instance, the graded spikes for workload 2 and workload 3 may be combined with a spike for workload 1 or a spike for workload 4. The combined spike is an example of the spike train 302.

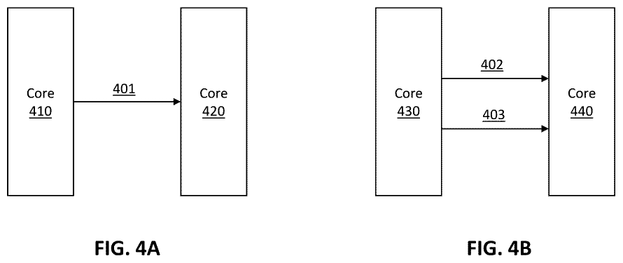

FIGS. 4A and 4B illustrate communicative connections between cores, in accordance with various embodiments. The cores are computing cores in a processing unit. In some embodiments, the processing unit is a neuromorphic unit, such as the neuromorphic unit 102 in FIG. 1. Each core is a neuron. The cores may be communicatively connected through one or more data paths in the processing unit. The connections between the cores can be preprogrammed, e.g., programmed before the parallel execution of workloads. In FIG. 4A, a core 410 and another core 420 are communicatively connected through one data path 401. The data path, for example, may have a width of 32 bits. In FIG. 4A, a core 430 and another core 440 are communicatively connected through two data paths 402 and 403, which have the same width as the data path 401. As there are two data paths, the total number of bits that can be passed between the core 430 and core 440 is 64 bits. The increase in the bandwidth can increase the total payload for a graded spike, meaning the effective payload capacity of graded spikes can be increased. That can enable more data to be transmitted per spike and thus enhance the data-carrying capability of the neuromorphic unit for complex tasks. Data throughput or processing capacity can be improved as well. FIGS. 4A and 4B, the data-carrying capability of the neuromorphic unit can be further increased by adding more connections between cores.

FIG. 5 illustrates an example spiking neuromorphic unit 500, in accordance with various embodiments. The spiking neuromorphic unit 500 is an example of at least part of the AI system 100 in FIG. 1. As shown in FIG. 5, the spiking neuromorphic unit 500 includes compute units 510 (individually referred to as “compute unit 510”), compute units 520 (individually referred to as “compute unit 520”), parallel input/output (IO) interfaces 530 (individually referred to as “parallel IO interface 530”), and a tour pin input/output (FPIO) interface 540. In other embodiments, alternative configurations, different or additional components may be included in the spiking neuromorphic unit 500. For example, the spiking neuromorphic unit 500 may include a different number of compute unit, parallel IO interface, or FPIO interface. As another example, the layout of the compute units 510 and 520 may be different. Further, functionality attributed to a component of the spiking neuromorphic unit 500 may be accomplished by a different component included in the spiking neuromorphic unit 500 or by a compute block.

The compute units 510 can execute neural network operations in DNNs. A compute unit 510 may include a plurality of neurons that may be integrated together. A neuron may be a compute element that can perform computations. For the purpose of illustration, a compute unit 510 includes nine neurons in FIG. 5. In other embodiments, a compute unit 510 may include a different number of neurons. For instance, the number of neurons in a compute unit 510 may be in a range from 100 to 1000. A compute unit 510 may be associated with a limited internal memory that can be accessed by the neurons during execution. The compute units 510 may be neuromorphic computing hardware. The compute units 510 may constitute a neuromorphic unit, such as the neuromorphic unit 102 in FIG. 1.

The neurons can communicate with each other asynchronously using binary (single-bit) or graded (multiple-bit) spikes or messages. In some embodiments, some or all the compute units 510 may be devoid of a clock. The notion of a time step may be maintained by a synchronization process that is a handshaking mechanism between the compute units 510 that is run when the spikes generated for each compute unit 510 are sent out. This can flush out all the remaining spiking activity and prepares the compute units 510 for the next algorithmic time step. Message passing can be done by using physical interconnects between the compute unit 510 or between neurons. The physical interconnects are represented by the dark lines and black circles in FIG. 5.

A compute unit 520 may be a CPU or part of a CPU (e.g., compact Von Neumann CPUs). The compute units 520 may execute special functions not tenable on the compute units 510, e.g., some or all functions of the DNN module 101 in FIG. 1. In some embodiments, the compute units 520 are implemented on the same chip(s) as the compute units 510. In other embodiments, the compute units 520 are implemented on separate chips from the compute units 510. The chip(s) can be scaled to increase the number of compute units 510 or 520, e.g., to accommodate large graphs. The chip-to-chip communication may be facilitated using the parallel IO interfaces 530 or the FPIO interface 540. The parallel IO interfaces 530 or the FPIO interface 540 can also offer support for Ethernet-based communication or other types of communications, such as slow serial communication.

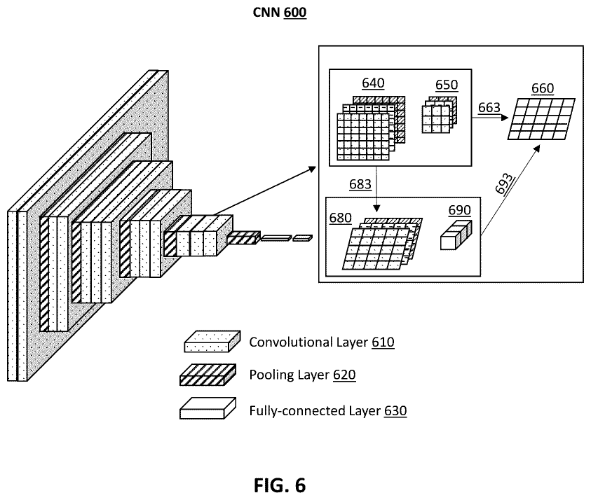

FIG. 6 illustrates a CNN 600, in accordance with various embodiments. The CNN 600 may be at least part of a DNN that can be used for image classification or other types of AI tasks. For the purpose of illustration, the CNN 600 includes a sequence of layers comprising a plurality of convolutional layers 610 (individually referred to as “convolutional layer 610”), a plurality of pooling layers 620 (individually referred to as “pooling layer 620”), and a plurality of fully-connected layers 630 (individually referred to as “fully-connected layer 630”). In other embodiments, the CNN 600 may include fewer, more, or different layers. In an execution of the CNN 600, the layers of the CNN 600 execute tensor computation that includes many tensor operations, such as convolutions, interpolations, pooling operations, elementwise operations (e.g., elementwise addition, elementwise multiplication, etc.), other types of tensor operations, or some combination thereof.

The convolutional layers 610 summarize the presence of features in inputs to the CNN 600. The convolutional layers 610 function as feature extractors. The first layer of the CNN 600 is a convolutional layer 610. In an example, a convolutional layer 610 performs a convolution on an input tensor 640 (also referred to as IFM 640) and a filter 650. As shown in FIG. 6, the IFM 640 is represented by a 7×7×3 three-dimensional (3D) matrix. The IFM 640 includes 3 input channels, each of which is represented by a 7×7 two-dimensional (2D) matrix. The 7×7 2D matrix includes 7 input elements (also referred to as input points) in each row and 7 input elements in each column. The filter 650 is represented by a 3×3×3 3D matrix. The filter 650 includes 3 kernels, each of which may correspond to a different input channel of the IFM 640. A kernel is a 2D matrix of weights, where the weights are arranged in columns and rows. A kernel can be smaller than the IFM. In the embodiments of FIG. 6, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 650 in extracting features from the IFM 640.

The convolution includes multiply-accumulate (MAC) operations with the input elements in the IFM 640 and the weights in the filter 650. The convolution may be a standard convolution 663 or a depthwise convolution 683. In the standard convolution 663, the whole filter 650 slides across the IFM 640. All the input channels are combined to produce an output tensor 660 (also referred to as output feature map (OFM) 660). The OFM 660 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 6. In embodiments where there are multiple filters, the standard convolution may produce multiple output channels in the OFM 660.

The multiplication applied between a kernel-sized patch of the IFM 640 and a kernel may be a dot product. A dot product is the elementwise multiplication between the kernel-sized patch of the IFM 640 and the corresponding kernel, which is then summed, always resulting in a single value. Because it results in a single value, the operation is often referred to as the “scalar product.” Using a kernel smaller than the IFM 640 is intentional as it allows the same kernel (set of weights) to be multiplied by the IFM 640 multiple times at different points on the IFM 640. Specifically, the kernel is applied systematically to each overlapping part or kernel-sized patch of the IFM 640, left to right, top to bottom. The result from multiplying the kernel with the IFM 640 one time is a single value. As the kernel is applied multiple times to the IFM 640, the multiplication result is a 2D matrix of output elements. As such, the 2D output matrix (i.e., the OFM 660) from the standard convolution 663 is referred to as an OFM.

In the depthwise convolution 683, the input channels are not combined. Rather, MAC operations are performed on an individual input channel and an individual kernel and produce an output channel. As shown in FIG. 6, the depthwise convolution 683 produces a depthwise output tensor 680. The depthwise output tensor 680 is represented by a 5×5×3 3D matrix. The depthwise output tensor 680 includes 3 output channels, each of which is represented by a 5×5 2D matrix. The 5×5 2D matrix includes 5 output elements in each row and 5 output elements in each column. Each output channel is a result of MAC operations of an input channel of the IFM 640 and a kernel of the filter 650. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 693 is then performed on the depthwise output tensor 680 and a 1×1×3 tensor 690 to produce the OFM 660. The tensor 690 is a 1D tensor.

The OFM 660 is then passed to the next layer in the sequence. In some embodiments, the OFM 660 is passed through an activation function. An example activation function is ReLU. ReLU is a calculation that returns the value provided as input directly, or the value zero if the input is zero or less. The convolutional layer 610 may receive several images as input and calculate the convolution of each of them with each of the kernels. This process can be repeated several times. For instance, the OFM 660 is passed to the subsequent convolutional layer 610 (i.e., the convolutional layer 610 following the convolutional layer 610 generating the OFM 660 in the sequence). The subsequent convolutional layers 610 perform a convolution on the OFM 660 with new kernels and generate a new feature map. The new feature map may also be normalized and resized. The new feature map can be kernelled again by a further subsequent convolutional layer 610, and so on.

In some embodiments, a convolutional layer 610 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 610). The convolutional layers 610 may perform various types of convolutions, such as 2D convolution, dilated or atrous convolution, spatial separable convolution, depthwise separable convolution, transposed convolution, and so on. The CNN 600 includes 66 convolutional layers 610. In other embodiments, the CNN 600 may include a different number of convolutional layers.

The pooling layers 620 down-sample feature maps generated by the convolutional layers, e.g., by summarizing the presence of features in the patches of the feature maps. A pooling layer 620 is placed between two convolutional layers 610: a preceding convolutional layer 610 (the convolutional layer 610 preceding the pooling layer 620 in the sequence of layers) and a subsequent convolutional layer 610 (the convolutional layer 610 subsequent to the pooling layer 620 in the sequence of layers). In some embodiments, a pooling layer 620 is added after a convolutional layer 610, e.g., after an activation function (e.g., ReLU, etc.) has been applied to the OFM 660.

A pooling layer 620 receives feature maps generated by the preceding convolutional layer 610 and applies a pooling operation to the feature maps. The pooling operation reduces the size of the feature maps while preserving their important characteristics. Accordingly, the pooling operation improves the efficiency of the DNN and avoids over-learning. The pooling layers 620 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 620 applied to a feature map of 6×6 results in an output pooled feature map of 3×3. The output of the pooling layer 620 is input into the subsequent convolutional layer 610 for further feature extraction. In some embodiments, the pooling layer 620 operates upon each feature map separately to create a new set of the same number of pooled feature maps.

The fully-connected layers 630 are the last layers of the DNN. The fully-connected layers 630 may be convolutional or not. The fully-connected layers 630 receive an input operand. The input operand defines the output of the convolutional layers 610 and pooling layers 620 and includes the values of the last feature map generated by the last pooling layer 620 in the sequence. The fully-connected layers 630 apply a linear combination and an activation function to the input operand and generate a vector. The vector may contain as many elements as there are classes: element i represents the probability that the image belongs to class i. Each element is therefore between 0 and 1, and the sum of all may be one. These probabilities are calculated by the last fully-connected layer 630 by using a logistic function (binary classification) or a SoftMax function (multi-class classification) as an activation function. In some embodiments, the fully-connected layers 630 multiply each input element by weight, make the sum, and then apply an activation function (e.g., logistic if N=2, SoftMax if N>2). This is equivalent to multiplying the input operand by the matrix containing the weights.

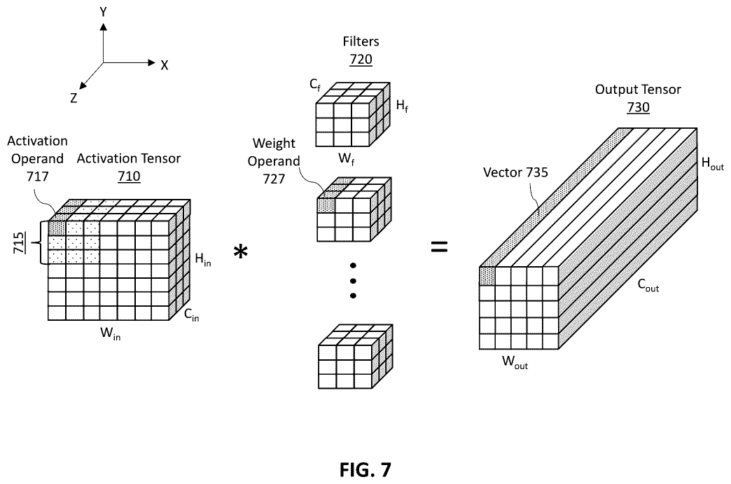

FIG. 7 illustrates an example convolution, in accordance with various embodiments. The convolution may be a deep learning operation in a convolutional layer of a DNN, e.g., a convolutional layer 610 in FIG. 6. The convolution can be executed on an activation tensor 710 and filters 720 (individually referred to as “filter 720”). The filters may constitute a weight tensor of the convolution. The result of the convolution is an output tensor 730.

The activation tensor 710 may be computed in a previous layer of the DNN. In some embodiments (e.g., embodiments where the convolutional layer is the first layer of the DNN), the activation tensor 710 may be an image. In the embodiments of FIG. 7, the activation tensor 710 includes activations (also referred to as “input activations,” “elements,” or “input elements”) arranged in a 3D matrix. The activation tensor 710 may also be referred to as an input tensor of the convolution. An input element is a data point in the activation tensor 710. The activation tensor 710 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For the purpose of simplicity and illustration, the activation tensor 710 has a spatial size of 7×7×3, i.e., the activation tensor 710 includes three input channels and each input channel has a 7×7 2D matrix. Each input element in the activation tensor 710 may be represented by a (X, Y, Z) coordinate. In other embodiments, the height, width, or depth of the activation tensor 710 may be different.

Each filter 720 includes weights arranged in a 3D matrix. The values of the weights may be determined through training the DNN. A filter 720 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 720 in FIG. 7 has a spatial size of 3×3×3, i.e., the filter 720 includes 7 convolutional kernels with a spatial size of 3×3. In other embodiments, the height, width, or depth of the filter 720 may be different. The spatial size of the convolutional kernels is smaller than the spatial size of the 2D matrix of each input channel in the activation tensor 710.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 720 slides across the activation tensor 710 and generates a 2D matrix for an output channel in the output tensor 730. In the embodiments of FIG. 7, the 2D matrix has a spatial size of 5×5. The output tensor 730 includes activations (also referred to as “output activations,” “elements,” or “output element”) arranged in a 3D matrix. An output activation is a data point in the output tensor 730. The output tensor 730 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 720 in the convolution. Hₒᵤₜ and Wₒᵤₜ may depend on the heights and weights of the activation tensor 710 and each filter 720. In an example where the kernel size is 1×1, Hₒᵤₜ and Wₒᵤₜ may equal to Hᵢₙ and Wᵢₙ, respectively.

As a part of the convolution, MAC operations can be performed on a 3×3×3 subtensor 715 (which is highlighted with a dotted pattern in FIG. 7) in the activation tensor 710 and each filter 720. The result of the MAC operations on the subtensor 715 and one filter 720 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 715 and all the filters 720 are finished, a vector 735 is produced. The vector 735 is highlighted with a dotted pattern in FIG. 7. The vector 735 includes a sequence of output activations, which are arranged along the Z axis. The output activations in the vector 735 have the same (x, y) coordinate, but the output activations correspond to different output channels and have different Z coordinates. The dimension of the vector 735 along the Z axis may equal the total number of output channels in the output tensor 730. After the vector 735 is produced, further MAC operations are performed to produce additional vectors till the output tensor 730 is produced. In the embodiments of FIG. 7, the output tensor 730 is computed in a Z-major format. When the output tensor 730 is computed in the ZXY format, the vector that is adjacent to the vector 735 along the X axis may be computed right after the vector 735. When the output tensor 730 is computed in the ZYX format, the vector that is adjacent to the vector 735 along the Y axis may be computed right after the vector 735. The output tensor 730 may be permuted and stored in a memory in an X-major format or Y-major format.

In some embodiments, the MAC operations on a 3×3×3 subtensor (e.g., the subtensor 715) and a filter 720 may be performed by a plurality of MAC units. One or more MAC units may receive an input operand (e.g., an activation operand 717 shown in FIG. 7) and a weight operand (e.g., the weight operand 727 shown in FIG. 7). The activation operand 717 includes a sequence of activations having the same (x, y) coordinate but different z coordinates. The activation operand 717 includes an activation from each of the input channels in the activation tensor 710. The weight operand 727 includes a sequence of weights having the same (x, y) coordinate but different z coordinates. The weight operand 727 includes a weight from each of the channels in the filter 720. Activations in the activation operand 717 and weights in the weight operand 727 may be sequentially fed into a MAC unit. The MAC unit may receive an activation and a weight (“an activation-weight pair”) at a time and multiple the activation and the weight. The position of the activation in the activation operand 717 may match the position of the weight in the weight operand 727. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 730 may be further processed based on one or more activation functions before they are written into the memory or input into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the activation tensor 710 may be results of post processing of the previous DNN layer.

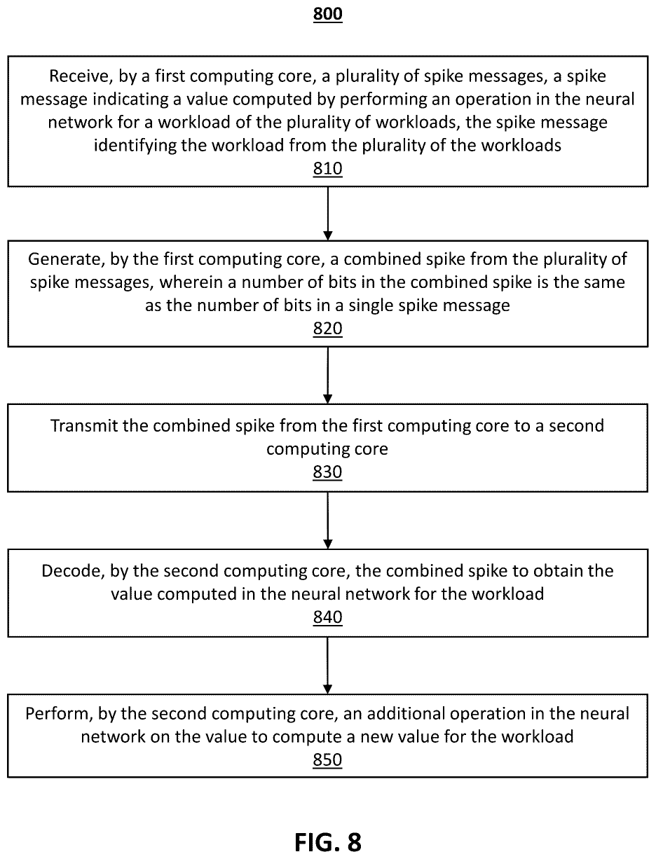

FIG. 8 is a flow chart showing a method 800 of parallel DNN workload processing, in accordance with various embodiments. Parallel DNN workload processing may be executing a DNN to simultaneously process a plurality of inputs through a plurality of workloads. The method 800 may be performed by the neuromorphic unit 102 in FIG. 1. Although the method 800 is described with reference to the flowchart illustrated in FIG. 8, many other methods for parallel DNN workload processing may alternatively be used. For example, the order of execution of the steps in FIG. 8 may be changed. As another example, some of the steps may be changed, eliminated, or combined.

The neuromorphic unit 102 receives 810, by a first computing core, a plurality of spike messages. A spike message indicates a value computed by performing an operation in the neural network for a workload of the plurality of workloads. The spike message identifies the workload from the plurality of the workloads. In some embodiments, the neuromorphic unit 102 generates the spike message by encoding the value based on a one-hot code that represents the workload, the one-hot code that comprising a single one bit and one or more zero bits. In some embodiments, the operation in the neural network is a convolution, and the value is a data element in an output tensor of the convolution.

The neuromorphic unit 102 generates 820, by the first computing core, a combined spike from the plurality of spike messages. A number of bits in the combined spike is the same as the number of bits in a single spike message. In some embodiments, the neuromorphic unit 102 determines whether a storage capacity of a buffer of the first computing core is reached after a last one of the plurality of spike messages is received by the first computing core. In response to determining that the storage capacity of the buffer is reached, the neuromorphic unit 102 combines the plurality of spike messages into the combined spike. In some embodiments, the neuromorphic unit 102 performs one or more OR operations on the plurality of spike messages to generate the combined spike.

The neuromorphic unit 102 transmits 830 the combined spike from the first computing core to a second computing core. In some embodiments, the neuromorphic unit 102 transmits the combined spike through one or more data paths between the first computing core and the second computing core. The number of bits in the combined spike is no more than a predetermined number of bits of the one or more data paths.

The neuromorphic unit 102 decodes 840, by the second computing core, the combined spike to obtain the value computed in the neural network for the workload. In some embodiments, the neuromorphic unit 102 computes one or more dot products from the combined spike and a one-hot code representing the workload.

The neuromorphic unit 102 performs 850, by the second computing core, an additional operation in the neural network on the value to compute a new value for the workload. In some embodiments, the neuromorphic unit 102 generates, by the second computing core, a new spike message by encoding the new value. The neuromorphic unit 102 transmits, by the second computing core, the new spike message to a third computing core.

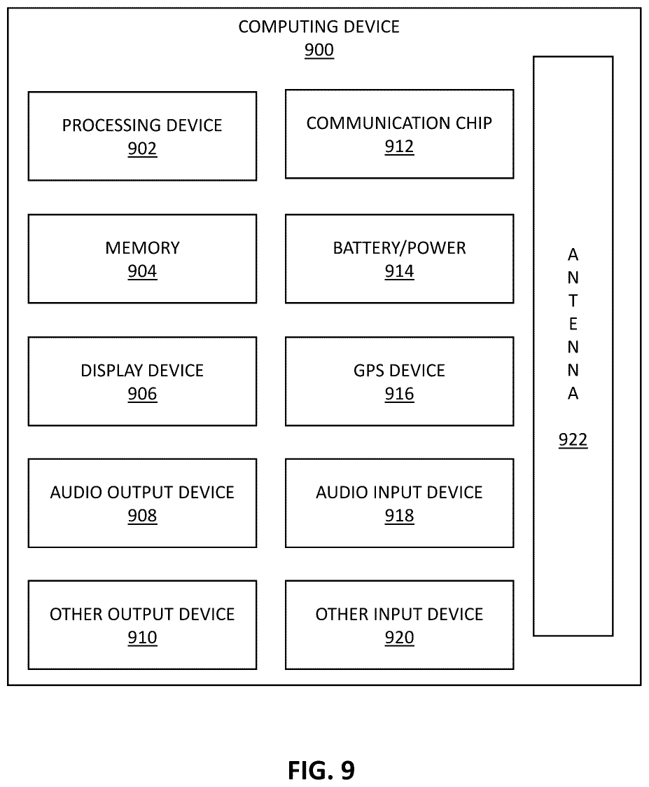

FIG. 9 is a block diagram of an example computing device 900, in accordance with various embodiments. In some embodiments, the computing device 900 may be used for at least part of the AI system 100 in FIG. 1. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include an audio input device 918 or an audio output device 908, but may include audio input or output device interface circuitry (e.g., connectors and supporting circuitry) to which an audio input device 918 or audio output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable for parallel DNN workload processing, e.g., the method 800 described above in conjunction with FIG. 8 or some operations performed by the AI system 100 in FIG. 1. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include an audio output device 908 (or corresponding interface circuitry, as discussed above). The audio output device 908 may include any device that generates an audible indicator, such as speakers, headsets, or earbuds, for example.

The computing device 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include an audio codec, a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

The following paragraphs provide various examples of the embodiments disclosed herein.

Example 1 provides an apparatus for executing a neural network to process a plurality of inputs through a plurality of workloads, the apparatus including a first computing core to: receive a plurality of spike messages, a spike message indicating a value computed by performing an operation in the neural network for a workload of the plurality of workloads, the spike message identifying the workload from the plurality of the workloads, and generate a combined spike message from the plurality of spike messages, in which a number of bits in the combined spike message is the same as the number of bits in a single spike message; and a second computing core to: receive the combined spike message from the first computing core, decode the combined spike message to obtain the value computed in the neural network for the workload, and perform an additional operation in the neural network on the value to compute a new value for the workload.

Example 2 provides the apparatus of example 1, in which the workload is represented by a one-hot code that includes a single one bit and one or more zero bits.

Example 3 provides the apparatus of example 2, in which the spike message is generated by encoding the value based on the one-hot code.

Example 4 provides the apparatus of any one of examples 1-3, in which the first computing core includes a buffer, and the neural is to store the plurality of spike messages in the buffer.

Example 5 provides the apparatus of example 4, in which the first computing core is to generate the combined spike message by: determining whether a storage capacity of the buffer is reached after a last one of the plurality of spike messages is received by the first computing core; and in response to determining that the storage capacity of the buffer is reached, combining the plurality of spike messages into the combined spike message.

Example 6 provides the apparatus of any one of examples 1-5, in which the first computing core is to generate the combined spike message by: performing one or more OR operations on the plurality of spike messages.

Example 7 provides the apparatus of any one of examples 1-6, in which the second computing core is to decode the combined spike message by: computing one or more dot products from the combined spike message and a one-hot code representing the workload.

Example 8 provides the apparatus of any one of examples 1-7, in which the second computing core is further to generate a new spike message by encoding the new value and to transmit the new spike message to a third computing core in the apparatus.

Example 9 provides the apparatus of any one of examples 1-8, further including one or more data paths between the first computing core and the second computing core, in which the number of bits in the combined spike message is no more than a predetermined number of bits of the one or more data paths.

Example 10 provides the apparatus of any one of examples 1-9, in which the operation in the neural network is a convolution, and the value is a data element in an output tensor of the convolution.

Example 11 provides a method for executing a neural network to process a plurality of inputs through a plurality of workloads, the method including receiving, by a first computing core, a plurality of spike messages, a spike message indicating a value computed by performing an operation in the neural network for a workload of the plurality of workloads, the spike message identifying the workload from the plurality of the workloads, and generating, by the first computing core, a combined spike message from the plurality of spike messages, in which a number of bits in the combined spike message is the same as the number of bits in a single spike message; transmitting the combined spike message from the first computing core to a second computing core; decoding, by the second computing core, the combined spike message to obtain the value computed in the neural network for the workload; and performing, by the second computing core, an additional operation in the neural network on the value to compute a new value for the workload.

Example 12 provides the method of example 11, further including generating the spike message by encoding the value based on a one-hot code that represents the workload, the one-hot code including a single one bit and one or more zero bits.

Example 13 provides the method of example 11 or 12, in which generating the combined spike message includes determining whether a storage capacity of a buffer of the first computing core is reached after a last one of the plurality of spike messages is received by the first computing core; and in response to determining that the storage capacity of the buffer is reached, combining the plurality of spike messages into the combined spike message.

Example 14 provides the method of any one of examples 11-13, in which generating the combined spike message includes performing one or more OR operations on the plurality of spike messages.

Example 15 provides the method of any one of examples 11-14, in which decoding the combined spike message includes computing one or more dot products from the combined spike message and a one-hot code representing the workload.

Example 16 provides the method of any one of examples 11-15, further including generating, by the second computing core, a new spike message by encoding the new value; and transmitting, by the second computing core, the new spike message to a third computing core.

Example 17 provides the method of any one of examples 11-16, in which transmitting the combined spike message from the first computing core to the second computing core includes transmitting the combined spike message through one or more data paths between the first computing core and the second computing core, in which the number of bits in the combined spike message is no more than a predetermined number of bits of the one or more data paths.

Example 18 provides one or more non-transitory computer-readable media storing instructions executable to perform operations for executing a neural network to process a plurality of inputs through a plurality of workloads, the operations including receiving, by a first computing core, a plurality of spike messages, a spike message indicating a value computed by performing an operation in the neural network for a workload of the plurality of workloads, the spike message identifying the workload from the plurality of the workloads, and generating, by the first computing core, a combined spike message from the plurality of spike messages, in which a number of bits in the combined spike message is the same as the number of bits in a single spike message; transmitting the combined spike message from the first computing core to a second computing core; decoding, by the second computing core, the combined spike message to obtain the value computed in the neural network for the workload; and performing, by the second computing core, an additional operation in the neural network on the value to compute a new value for the workload.

Example 19 provides the one or more non-transitory computer-readable media of example 18, in which the operations further include generating the spike message by encoding the value based on a one-hot code that represents the workload, the one-hot code including a single one bit and one or more zero bits.

Example 20 provides the one or more non-transitory computer-readable media of example 18 or 19, in which generating the combined spike message includes performing one or more OR operations on the plurality of spike messages.

Example 21 provides the one or more non-transitory computer-readable media of any one of examples 18-20, in which decoding the combined spike message includes computing one or more dot products from the combined spike message and a one-hot code representing the workload.

Example 22 provides the one or more non-transitory computer-readable media of any one of examples 18-21, in which generating the combined spike message includes determining whether a storage capacity of a buffer of the first computing core is reached after a last one of the plurality of spike messages is received by the first computing core; and in response to determining that the storage capacity of the buffer is reached, combining the plurality of spike messages into the combined spike message.

Example 23 provides the one or more non-transitory computer-readable media of any one of examples 18-22, in which the operations further include generating, by the second computing core, a new spike message by encoding the new value; and transmitting, by the second computing core, the new spike message to a third computing core.

Example 24 provides the one or more non-transitory computer-readable media of any one of examples 18-25, in which transmitting the combined spike message from the first computing core to the second computing core includes transmitting the combined spike message through one or more data paths between the first computing core and the second computing core, in which the number of bits in the combined spike message is no more than a predetermined number of bits of the one or more data paths.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An apparatus for executing a neural network to process a plurality of inputs through a plurality of workloads, the apparatus comprising:
a first computing core to:
receive a plurality of spike messages, a spike message indicating a value computed by performing an operation in the neural network for a workload of the plurality of workloads, the spike message identifying the workload from the plurality of the workloads, and
generate a combined spike message from the plurality of spike messages, wherein a number of bits in the combined spike message is the same as the number of bits in a single spike message; and
a second computing core to:
receive the combined spike message from the first computing core,
decode the combined spike message to obtain the value computed in the neural network for the workload, and
perform an additional operation in the neural network on the value to compute a new value for the workload.

2. The apparatus of claim 1, wherein the workload is represented by a one-hot code that comprises a single one bit and one or more zero bits.

3. The apparatus of claim 2, wherein the spike message is generated by encoding the value based on the one-hot code.

4. The apparatus of claim 1, wherein the first computing core comprises a buffer, and the neural is to store the plurality of spike messages in the buffer.

5. The apparatus of claim 4, wherein the first computing core is to generate the combined spike message by:
determining whether a storage capacity of the buffer is reached after a last one of the plurality of spike messages is received by the first computing core; and
in response to determining that the storage capacity of the buffer is reached, combining the plurality of spike messages into the combined spike message.

6. The apparatus of claim 1, wherein the first computing core is to generate the combined spike message by:
performing one or more OR operations on the plurality of spike messages.

7. The apparatus of claim 1, wherein the second computing core is to decode the combined spike message by:
computing one or more dot products from the combined spike message and a one-hot code representing the workload.

8. The apparatus of claim 1, wherein the second computing core is further to generate a new spike message by encoding the new value and to transmit the new spike message to a third computing core in the apparatus.

9. The apparatus of claim 1, further comprising one or more data paths between the first computing core and the second computing core, wherein the number of bits in the combined spike message is no more than a predetermined number of bits of the one or more data paths.

10. The apparatus of claim 1, wherein the operation in the neural network is a convolution, and the value is a data element in an output tensor of the convolution.

11. A method for executing a neural network to process a plurality of inputs through a plurality of workloads, the method comprising:
receiving, by a first computing core, a plurality of spike messages, a spike message indicating a value computed by performing an operation in the neural network for a workload of the plurality of workloads, the spike message identifying the workload from the plurality of the workloads, and
generating, by the first computing core, a combined spike message from the plurality of spike messages, wherein a number of bits in the combined spike message is the same as the number of bits in a single spike message;
transmitting the combined spike message from the first computing core to a second computing core;
decoding, by the second computing core, the combined spike message to obtain the value computed in the neural network for the workload; and
performing, by the second computing core, an additional operation in the neural network on the value to compute a new value for the workload.

12. The method of claim 11, further comprising:
generating the spike message by encoding the value based on a one-hot code that represents the workload, the one-hot code comprising a single one bit and one or more zero bits.

13. The method of claim 11, wherein generating the combined spike message comprises:
determining whether a storage capacity of a buffer of the first computing core is reached after a last one of the plurality of spike messages is received by the first computing core; and
in response to determining that the storage capacity of the buffer is reached, combining the plurality of spike messages into the combined spike message.

14. The method of claim 11, wherein generating the combined spike message comprises:
performing one or more OR operations on the plurality of spike messages.

15. The method of claim 11, wherein decoding the combined spike message comprises:
computing one or more dot products from the combined spike message and a one-hot code representing the workload.

16. The method of claim 11, further comprising:
generating, by the second computing core, a new spike message by encoding the new value; and
transmitting, by the second computing core, the new spike message to a third computing core.

17. The method of claim 11, wherein transmitting the combined spike message from the first computing core to the second computing core comprises:
transmitting the combined spike message through one or more data paths between the first computing core and the second computing core,
wherein the number of bits in the combined spike message is no more than a predetermined number of bits of the one or more data paths.

18. One or more non-transitory computer-readable media storing instructions executable to perform operations for executing a neural network to process a plurality of inputs through a plurality of workloads, the operations comprising:
receiving, by a first computing core, a plurality of spike messages, a spike message indicating a value computed by performing an operation in the neural network for a workload of the plurality of workloads, the spike message identifying the workload from the plurality of the workloads, and
generating, by the first computing core, a combined spike message from the plurality of spike messages, wherein a number of bits in the combined spike message is the same as the number of bits in a single spike message;
transmitting the combined spike message from the first computing core to a second computing core;
decoding, by the second computing core, the combined spike message to obtain the value computed in the neural network for the workload; and
performing, by the second computing core, an additional operation in the neural network on the value to compute a new value for the workload.

19. The one or more non-transitory computer-readable media of claim 18, wherein the operations further comprise:
generating the spike message by encoding the value based on a one-hot code that represents the workload, the one-hot code comprising a single one bit and one or more zero bits.

20. The one or more non-transitory computer-readable media of claim 18, wherein generating the combined spike message comprises performing one or more OR operations on the plurality of spike messages, wherein decoding the combined spike message comprises computing one or more dot products from the combined spike message and a one-hot code representing the workload.
